(19) United States
(12) Patent Application Publication
(10) Pub. No.: US 2006/0015391 A1
(43) Pub. Date: Jan. 19, 2006

(54) Automated voter registration campaign management

(75) Inventors: David D. Greene, Washington, DC (US); Marvin R. Randolph, Washington, DC (US)

Correspondence Address: BARNES & THORNBURG, Suite 900, 750 17th Street, N.W., Washington, DC, 20006, US

(73) Assignee: Urbanomics Consulting Group

(21) Appl. No.: 11/147,274

(22) Filed: Jun. 8, 2005

Related U.S. Application Data
(60) Provisional application No. 60/577,603, filed on Jun. 8, 2004.

(51) Int. Cl. G06Q 99/00

(52) U.S. Cl. 705/10

(57) ABSTRACT

An automated voter registration campaign management system and method includes collecting information and determining of one or more parameters of registrations per hour, phone number percentages for new registrants, volunteer recruitment percentage, contact rate and verification rate. Next the determined parameters is compared against predetermined targets; and a variance report is generated.

This application claims benefit of U.S. provisional patent application Ser. No. 60/577,603, filed Jun. 8, 2004 and which is incorporated herein by reference.

### BACKGROUND OF THE DISCLOSURE

The present disclosure is related generally to management of voter registration, including setting appropriate goals, training the personnel to implement the goals and monitoring the results as the campaign progresses. Various methods have been used. One particular method is available from Urbanomics Consulting Group, which is the assignee of the present disclosure.

The registration campaign staff structure is illustrated in FIG. 1. Depending upon whether it is a canvass door-to-door or a site location, there are those who are on the canvass or site team and a canvass or site supervisor. A plurality of supervisors report to a local organizer who reports to a county coordinator who reports to state directors. If the campaign is funded, the state director reports the results to the funder, who then disperses an appropriate amount of funds based on the goals.

For management purposes, the goals may be set as illustrated in FIG. 2. There is a registration goal. There is a suggested shift time. A contact rate and success rate, as well as accuracy rate, are predetermined. This is used to determine the appropriate staffing. If it is a canvass versus a site, these variable are also set based on the spacing of the houses and the anticipated concentration of eligible voters. In order to collect information which can be used in managing the campaign, various reports must be prepared. FIG. 3 is a daily volunteer tally sheet for a site team. Besides the identification information, it tallies the number of new registrants, the hours worked, the volunteers recruited, the type of registration activity, as well as the description of the activity or site. The project coordinator, which may be a local organizer or the county organizer, determines the number of new registrants, the number of forms with telephone numbers and the percentage of forms with telephone numbers. He or she also determines whether the forms are complete and neatly filled out, makes sure that 10 percent of the people on the forms have been called, makes sure that the forms have been photocopied and collects the daily tallies into a weekly report.

For a canvass versus a site, a tally sheet, as illustrated in FIG. 4, is used. Besides the identification information, it includes the number of doors knocked on, the number of doors answered, the number of registrants and the volunteers recruited. Although not shown, the project coordinator will also do the same tallying and verification described for FIG. 3. The local organizer fills out a daily report form, which is illustrated in FIG. 5. Besides the identification material, it summarizes the volunteers recruited, the voters registered with or without telephones, the number of hours worked and the registration per volunteer or hours canvassed. The local organizer may also have a weekly report, as illustrated in FIG. 6, which summarizes much of the same material but includes goals for the week, as well as new goals for the following week. The county coordinator also prepares a weekly report, as illustrated in FIG. 7, which also includes the projections for the next week to achieve the goals. The state director's weekly report is illustrated in FIG. 8. Based on the batch sheet of FIG. 9, the grant maker disperses appropriate funds.

### SUMMARY OF THE DISCLOSURE

The present system is an automated voter registration campaign management system and method. It includes collecting information and determining of one or more parameters of registrations per hour, phone number percentages for new registrants, volunteer recruitment percentage, contact rate and verification rate. Next the determined parameters is compared against predetermined targets; and a variance report is generated.

With the present automated system, appropriate goals can be set based on prior knowledge of the area being canvassed and history of the workers, if available. It also includes the ability to determine appropriate goals and adjust goals as the campaign goes forward. This allows effective management of the campaign even by inexperienced supervisors, organizers, coordinators or directors. The system may be implemented in a standalone location or may be a web-based reporting system.

The present system will allow users to track and monitor progress as well as adjust hourly, daily and weekly voter registration goals. The system will also make it possible to understand and report those factors that impact campaigns that no level of planning can eliminate, such as inclement weather.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a registration campaign staff structure. FIG. 2 illustrates accountability-goal setting math. FIG. 3 is a daily volunteer tally sheet. FIG. 4 is a canvasser daily tally sheet. FIG. 5 is a site/precinct daily report. FIG. 6 is a local organizer weekly report. FIG. 7 is a county coordinator weekly report. FIG. 8 is a state director weekly report. FIG. 9 is a worker batch sheet.

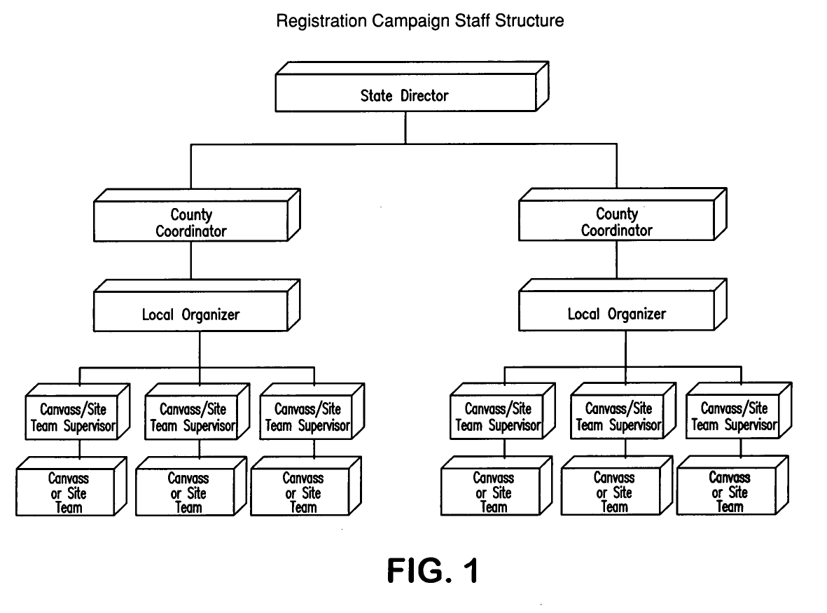

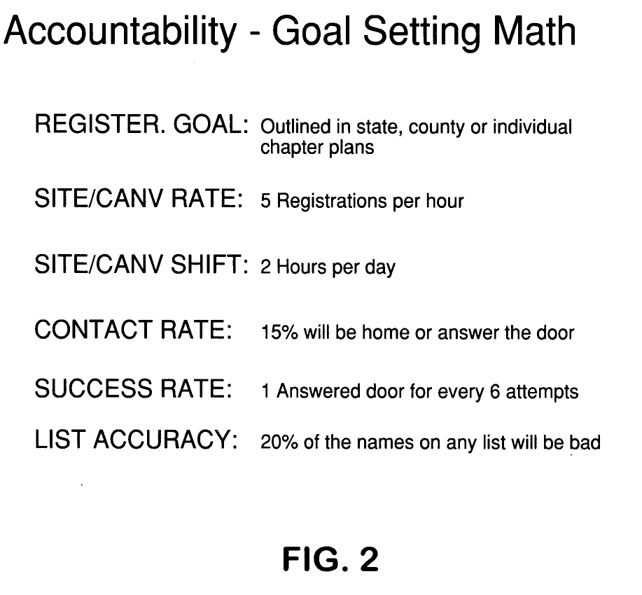

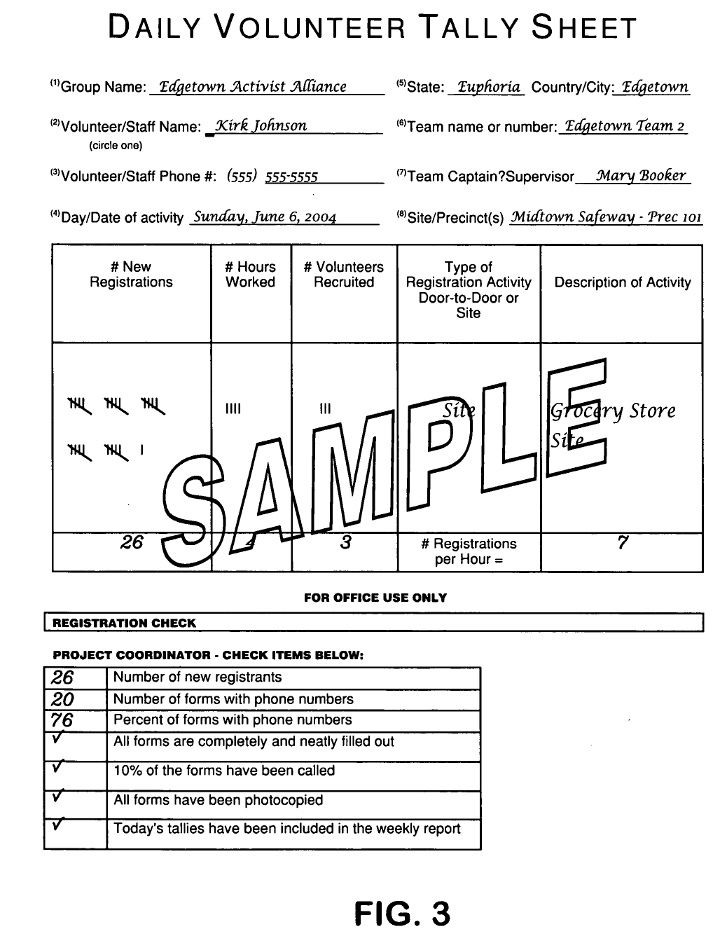

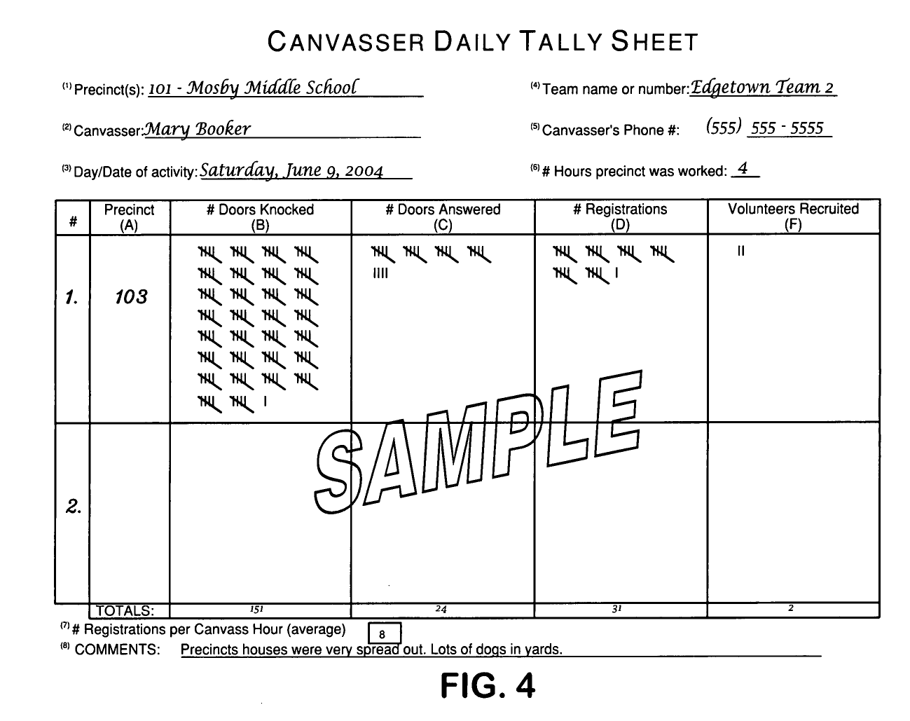

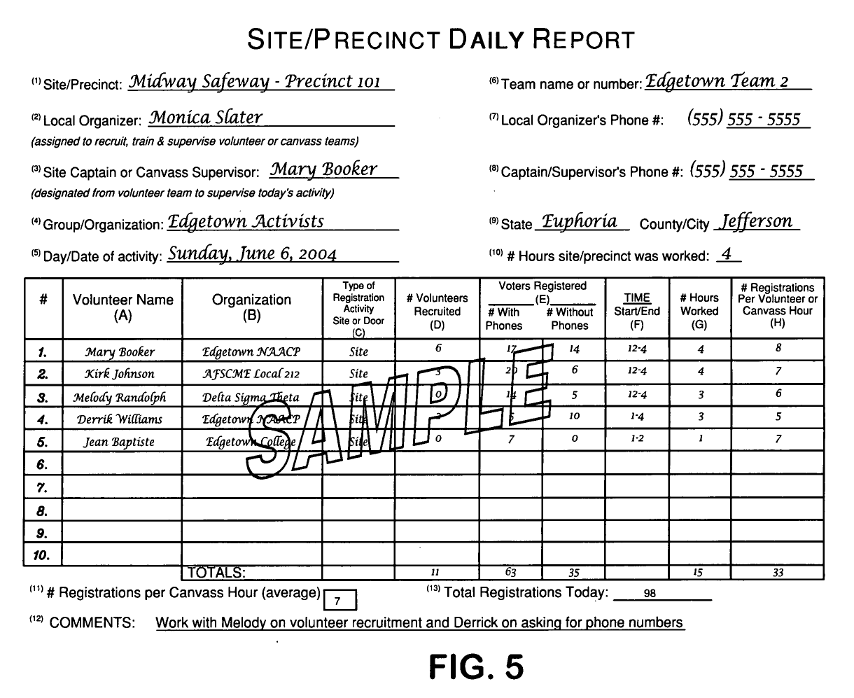

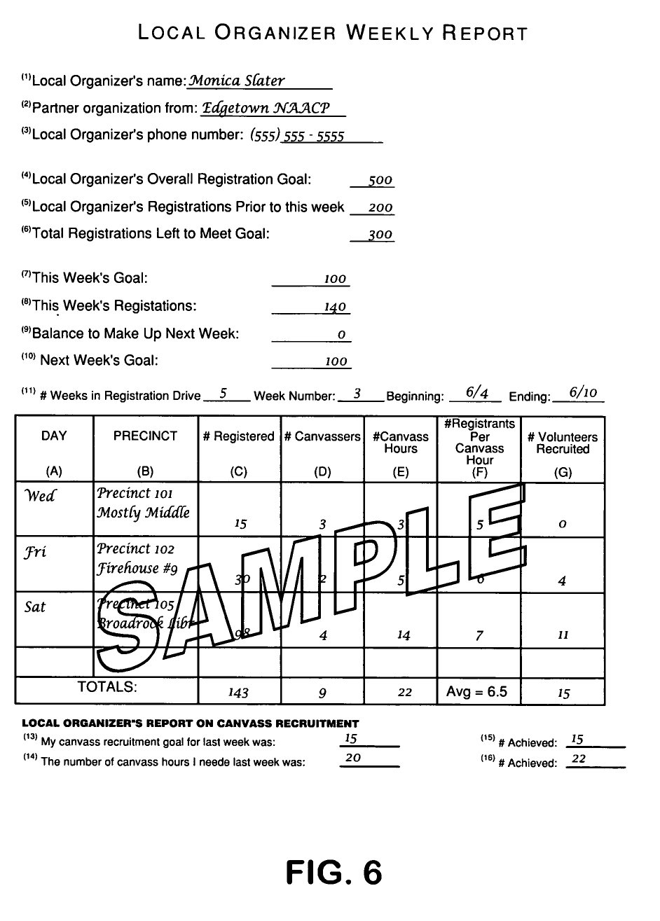

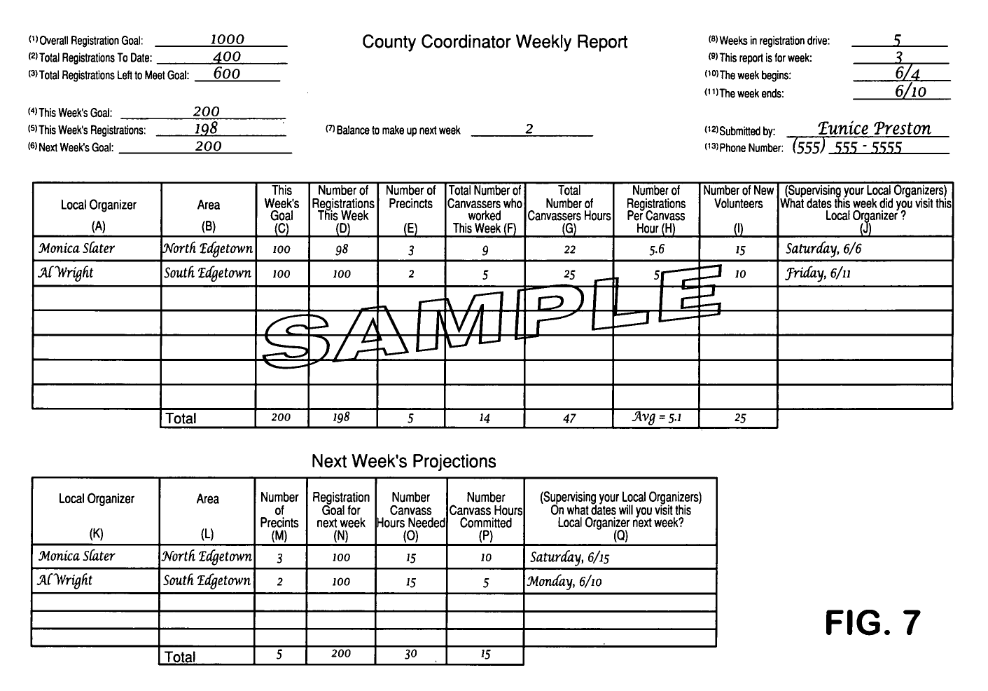

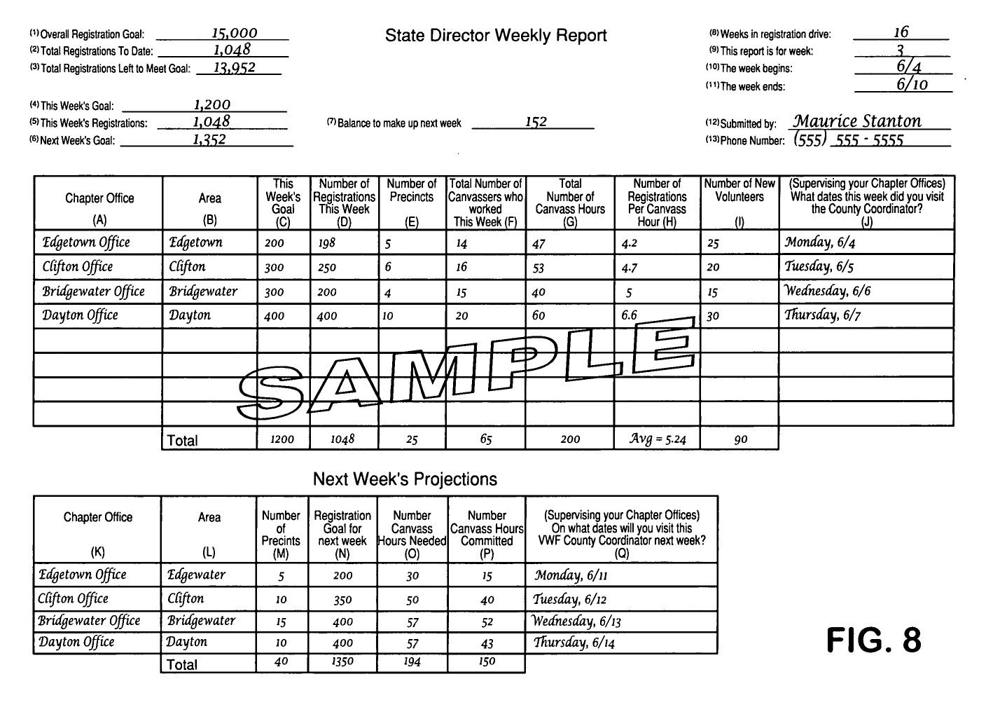

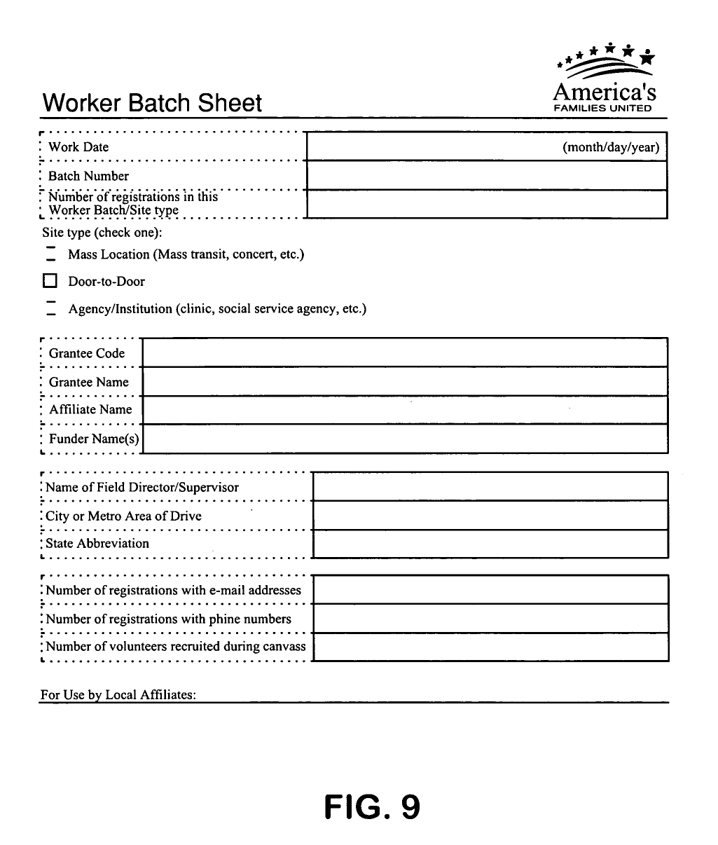

### DETAILED DESCRIPTION OF THE PREFERRED EMBODIMENT

As previously described and illustrated in the reports of FIGS. 3-9, the information need for analysis includes:

DIAGRAM 1A.

| CANVASS REGISTRATION | |
|---|---|
| REPORT | SITE REGISTRATION REPORT |
| 1. Number of working hours | 1. Number of working hours |
| 2. Number of door visited | 2. |
| 3. Number of registrants for the | 3. Number of registrants for the |
| day | day |
| 4. Number of volunteers recruited | 4. Number of volunteers recruited |
| 5. Number of registrants per hour | 5. Number of registrants per hour |

DIAGRAM 2B.

| | CANVASS REGISTRATION |
|---|---|
| SITE REGISTRATION REPORT | REPORT |
| Organizer | Organizer |
| 1. Site(1 - ?) | 1. Canvasser (1 - 4) |
| 2. Site Captain # (1 - ?) | 2. Canvass Supervisor # (1 - ?) |
| 3. Site Worker # (1 - ?) | 3. Precinct Number |
| 4. County | 4. County |
| 5. State | 5. State |
| 6. Organization(s) | 6. Organization(s) |

The system works as follows:
1. Results-Based Reporting
Organizing Director gathers and compiles information from canvasser tally sheets and transfers it from paper to the online user interface form.
2. Daily Accounting/Random Selection Verification
Canvass Director notes daily accounting and verifies by calling 10% of the list and approves and forwards report onto State Director.
3. Submission for Batching
State Director notes adjustments where needed and submits report to grant maker for approval for batching. State Director notes adjustments where needed and submits report to grant maker for approval for batching.
4. Batching and Dispatch
Once grant makers designee approves report, it is approved and voter registration cards are bundled, batched and dispatched for delivery to data house.

The system will allow user to generate daily and weekly reports from information inputted and compiled from the forms of FIGS. 3-9, for example as a part of its national voter registration-training program. The system's end-user interface is a standard form comprised of text and numerical fields.

Driven by a back-end database that extracts data from the form and compiles information into columns from the form's interface, the system will allow for outputting a variety of reports based on analysis of the data described above in Diagrams 1A and 2B.

Additionally, the system will assign a unique alphanumeric code for each person working on the campaign. This code will act as an identifier that associates all information with a person working on the campaign. This identifier will also make it possible to query and generate reports by individual to allow for planning, coaching and training. It will also allow prescreening of workers in this and/or future campaigns.

For tracking, monitoring and adjustment purposes, the system will rely upon a series of formulaic references to calculate and establish a means for determining how many registrants need to be registered based on a pre-determined number of eligible voters and voter registration deadlines for each respective state. A series of embedded formulas will allow for calculations within forms used for inputting information from the canvass report and extracted and automatically inserted in County and State interface forms. These formulas will also allow hours for each shift to be determined, the number of volunteers to plan to recruit based on type of voter registration operation being managed—site and canvass operations.

When reported numbers fall below the target numbers, based on type of voter registration drive, location and day of the campaign, the form interface will alert the user with different colored font typeface. For planning, coaching and training purposes, the system will allow for exporting data in various formatted files (Excel, Word, etc.). Once information has been exported, newly adjusted plan and estimates will be able to be developed from adjusting timelines, number of staff, number of teams and locations. The system can also determine and export the adjusted plan and estimate.

Thus, the system provides variable reporting in addition to automation of data analysis. This automated data analysis function will provide users with a level of inquiry not available to even veterans of voter registration campaigns because of the level and variation of computation involved, thereby making it possible to access, retrieve, analyze, compute and output dozens of reports to inform decisions about resource allocation and goal adjustments.

At the core of the system are updated forms, which represent the framework for the system. These forms, similar to those of FIGS. 3-9, allow space for identifying factors that act as obstacles to the campaign and thereby threaten goals. Additionally, a coding system allows users to track, compile, categorize and report factors that impact the campaign, such as:
Condition of terrain
Actual number of streets (blocks) where applicable canvassed
Weather conditions
Incorrect Data
Percentage of list that was bad
Percentage of households without phone numbers
Encumbered walk routes
Staff changes or shortages
Language barriers
Holidays (Federal, Religious, etc.)
Equipment shortage of failure
Material shortages
   These factors will allow analysis of the quality of the solicitation and teams more fairly which still allowing adjustment of the weekly goals and staffing.

Examples of algorithms to drive report outputs are:
number of registrants per hour;
phone number percentages for new registrants;
volunteer recruitment percentage;
contact rate; and
verification rate.
   These computation formulas will allow measurement of the progress against some baseline of information.

The system would allow the analysis to be viewed and computed by:
a. organizer (the person supervising the canvass or site teams),
b. county,
c. state, or
d. national organization.
   1. Registrations per Hour

Using as an example, the average should be five registrations per hour. This may be on an individual, team, county, state, etc. bases. All daily results are measured against the daily goal; the daily goal for the team, for the county, for the state and for the organization and for the donor. If the registration rate for an individual team is an average of five per hour, then the team is fine and on track to meeting its goal. If the registration rate for an individual team is BELOW an average of five per hour, the individual canvassers or team members would then be VISUALLY NOTED in the system (i.e., their assigned number would turn a different color, etc.), and their percentage of performance below the team average (which is what's dragging the team down) would appear on the screen—thus marking that canvasser or site worker or team for review or evaluation of their technique, rap, approach. The comparison to the averages of other teams could also be provided for analysis.

After a series of consecutive flags (noting that there has not been improvement in the individual canvasser or site worker), the system would flag that worker or canvasser for:
a. more intensive evaluation,
b. more coaching,
c. training,
d. termination, and/or
e. replacement.

Further registrations could be measured by averages applying to the form of registration allowed. Formulas for determining this would include average registration per hour rates for the following:
Post card registration with NO BARRIERS (i.e., no swearing or affidavit signing, notarization, ID or official deputized registrar presence required.)
Post card registration WITH BARRIERS (i.e., swearing or affidavit signing, notarization, ID or official deputized registrar presence required.)

For example, the registration rate should average no lower than five per hour by an average of 12% in a canvass operation and 10% in a site operation. The conversion rate (or the ratio of people talked to versus those who agree to register) should average no lower than 35%. Another way to look at this is that it is the “contact rate” (see #4 below) measured against the “registration rate.”

2. Phone Number Percentages for New Registrant

Each individual worker's (site worker or canvass worker) or team percentage of new registrants with phone numbers should meet the average of the team for that given day. All daily results are measured against the team's (site team's or canvass team's) daily percentage of registrants with phone numbers. If the phone number percentage for an individual team is below the average of that of another team operating in the same precinct in the tracking system, these individual canvassers or team members would then be VISUALLY NOTED in the system (i.e., their assigned number would turn a different color, etc.), and their percentage of performance below the team average (which is what is dragging the team down) would appear on the screen—thus marking that canvasser or site worker for review or evaluation of their technique, rap, approach.

After a series of consecutive flags (noting that there has not been improvement in the individual canvasser or site worker), the system would flag that worker or canvasser for:
a. more intensive evaluation,
b. more coaching,
c. training,
d. termination, and/or
e. replacement.
   3. Volunteer Recruitment Percentages

Each individual worker's (site worker or canvass worker) or teams percentage of new registrants with phone numbers should meet the average of the team for that given day.

All daily results are measured against the team's (site team's or canvass team's) daily percentage of registrants recruited as volunteers. If the volunteer recruitment percentage for an individual team is below the average of that of another team operating in the same precinct in the tracking system, these individual canvassers or team members would then be VISUALLY NOTED in the system (i.e., their assigned number would turn a different color, etc.), and their percentage of performance below the team average (which is what is dragging the team down) would appear on the screen—thus marking that canvasser or site worker for review or evaluation of their technique, rap, approach.

After a series of consecutive flags (noting that there has not been improvement in the individual canvasser or site worker), the system would flag that worker or canvasser for:
a. more intensive evaluation,
b. more coaching,
c. training,
d. termination, and/or
e. replacement.
   4. Contact Rate

Each individual canvasser's or team's rate of contact with registrants should:
a. meet the average of the team for that given day, and
b. in instances of canvass registration, meet a contact rate of:
   _doors per hour for precinct areas (turf) indicated as “dense—or urban”
   _doors per hour for precinct areas (turf) indicated as “spread out—or rural”
   _doors per hour for precinct areas (turf) indicated as “gated” (as in requiring entrance through a secured gate to get access to the residences)
   _doors per hour for precinct areas (turf) indicated as “guarded” (as in requiring entrance through approval of a secured guard of some type to get access to the residences).

Each site worker's rate of contact with registrants should:
a. meet the average of the team for that given day, and
b. in instances of site registration, meet a contact rate of:
   _approaches per hour for sites indicated as “heavy traffic”
   _approaches per hour for sites indicated as “medium traffic”
   _approaches per hour for sites indicated as “light traffic.”

Again, all daily results are measured against the daily goal (by team, precinct, organizer, county, state or national organization). For sites and site workers (like canvass precincts and canvassers), the area worked that day should be scouted and indicated as meeting one of the above categories (heavy, medium or light traffic). Once the site data has come back for the day, the system should analyze the average rates of contacts per hour to correct (or re-designate) that site as being marked appropriately (again, as heavy, medium or light traffic).

The registration rate, and whether the number of registrations per hour for individual canvassers, teams, counties or states are causing any of these entities to perform below the daily average registration rate required to meet the goal would be compared to have the system indicate whether or not the level of traffic indicated at the site is too low.

The system could even run comparative averages over time to see what is the contact rate that assures peak, ideal or even minimal performance required to meet needed goals. The same criteria and analysis could be applied to the canvass operation.

The contact rate for canvassing should average no lower than 15%, for example.

5. Verification Rate

From the list of registrants turned in daily by each individual worker (site worker of canvass worker) or team, at least 10% of the names will be called for verification. The system should indicate individual canvassers, site workers, teams, county and state operations, etc. that have unusually low verifications. The analysis would occur by producing a percentage of the new registrants called that are confirmed to be correctly identified as “who or what” is listed on the form that has been turned in.

Benefits of the Application System

The benefits of the application system include:
1. Allows for more effective use of project resources (time, people and money).
2. Allows for more accurate accounting of allocated funding.
3. Allows management at all levels of the organization to view progress of project.
4. Allows user to instantly determine if voter registration project plan is on or off course.
5. Allows for more effective coalition building among organizations with different purposes.

Although the present invention has been described and illustrated in detail, it is to be clearly understood that the same is by way of illustration and example only, and is not to be taken by way of limitation. The spirit and scope of the present invention are to be limited only by the terms of the appended claims.

What is claimed:

1. An automated voter registration campaign management system and method comprising:
collecting information and determining of one or more parameters of registrations per hour, phone number percentages for new registrants, volunteer recruitment percentage, contact rate and verification rate;
comparing the determined parameters against predetermined targets; and
generating a variance report.
